(19) United States
(12) Patent Application Publication
(10) Pub. No.: US 2025/0145530 A1
(43) Pub. Date: May 8, 2025

(54) USE OF ALKALI-SENSITIVE AGGREGATE FOR CONCRETE PRODUCTION, CONCRETE MIXTURE, CONCRETE AND PROCESS FOR PRODUCTION THEREOF

(71) Applicant: OLIMENT® GmbH, Rötha OT Espenhain (DE)

(72) Inventors: Frank Bellmann, Weimar (DE); Horst-Michael Ludwig, Weimar (DE)

(21) Appl. No.: 18/691,041

(22) PCT Filed: Dec. 22, 2022
(86) PCT No.: PCT/EP2022/087396

§ 371 Date: Mar. 11, 2024

(30) Foreign Application Priority Data
Dec. 23, 2021 (DE) 10 2021 134 532.4

(51) Int. Cl. C04B 28/10; C04B 111/10

(52) U.S. Cl. CPC C04B 28/10; C04B 2111/10

(57) ABSTRACT

A concrete mixture is specified, comprising a cement composition and an aggregate, characterized in that the cement composition contains an olivine-based binder, and the aggregate is an alkali-sensitive aggregate. Also specified in the context of the invention are a process for producing concrete using the concrete mixture, a concrete, and the use of the concrete mixture for production of concrete with avoidance and/or reduction of the alkali-silica reaction.

The present invention relates to a concrete mixture according to the subject matter of claim 1, a process for the production of concrete according to the subject matter of claim 8, as well as a concrete according to the subject matter of claim 9.

Concrete is manufactured from cement, water and stone aggregate. For an appropriate utilization, the long-term stability of the material must be guaranteed. For this reason, requirements are made with respect to the initial materials, which are proven by according quality controls. An important requirement for the use of a stone aggregate is to avoid a reaction with the cement which can lead to a damage of the concrete in the form of swelling appearances and cracks, and is designated as alkali-silicic acid reaction (AKR).

The control of the stone aggregate and the position of the extraction site entail a grouping into the classes E-I to E-III of the alkali guideline. Rocks of the category E-II and E-III are only allowed to be used conditionally for the production of concrete. These materials contain responsive SiO₂, which can react with the alkali and hydroxide ions from the pore solution of the cement stone to iso-called AKR-gel which may entail a damage.

For the reasons described, a part of the stone aggregate deposition sites may not be used for concrete production.

Before this background, the task of the present invention is to enable the use of a wider group of stone aggregate.

The task is solved by a concrete mixture according to claim 1, a method for producing according to claim 8, a concrete according to the subject matter of claim 9, and a use of the concrete mixture according to the subject matter of claim 12 or a use of an olivine-based binder according to the subject matter of claim 13.

Advantageous further developments of the invention result from the subclaims.

The problem of the invention is in particular solved by a concrete mixture containing a cement composition and a stone aggregate, wherein the cement composition contains an olivine-based binder, and the stone aggregate is an alkali-sensitive stone aggregate.

An essential aspect of the invention is the use of an olivine-based binder in particular in combination with an alkali-sensitive stone aggregate. Olivine-based binders feature a pore solution composition which cannot lead to an alkali-silicic acid reaction. Accordingly, also a use of stone aggregates of the categories E-II and E-III is possible in concrete construction with the inventive concrete mixture since olivine-based binders are used.

Alkali-sensitive stone aggregates of all categories may be used when the hydroxide ion solution and the alkali concentration in the pore solution are very low. This is ensured by using an olivine-based binder. After hardening of such binders, the pH-value of the pore solution is almost neutral (approximately 7 to 10), and this corresponds to hydroxide ion concentrations of below 0.1 mmol/l. The alkali concentration in the pore solution depends on the exact binder composition, however is always several magnitudes below the alkali concentration of cements according to DIN EN 197.

Olivin a is a mineral of the general composition A₂SiO₄, wherein A may represent different divalent ions such as magnesium (Forsterit, Mg₂SiO₄), iron (Fe₂SiO₄, Fayalit), manganese (Mn₂SiO₄, Tephroit) as well as further ions and a combination of the different cations since olivine is a mixed crystal series. Among the olivine-rich aggregates which can be used for producing olivine-based binders, are Dunit, Wehrlit, Habsburgit and more. Theses stones frequently have a lower degree of weathering. As the raw materials, natural stones and/or industrially occurring material having a high olivine content may be used.

In one aspect, the problem of the invention is in particular solved by a concrete mixture containing a cement composition and a stone aggregate, wherein the sum of magnesium oxide and iron oxide in the cement composition is 20% by weight to 70% by weight, wherein the cement composition contains 20% by weight to 70% by weight of SiO₂, and wherein the stone aggregate is an alkali-sensitive stone aggregate. In one embodiment of this aspect, the cement composition contains 20% by weight to 50% by weight of magnesium oxide and 2% by weight to 10% by weight of iron oxide. In one embodiment of this aspect, the cement composition contains 0.1% by weight to 5% by weight of calcium oxide.

According to a preferred embodiment, the stone aggregate is a stone aggregate of the category E-II or E-III according to the DAfStb alkali-guideline: 2013-10.

Accordingly, a stone aggregate may be used according to the invention, which is vulnerable for the alkali-silicic acid reaction.

According to a preferred embodiment, the stone aggregate includes a stone selected from flint, opaline sandstone, siliceous chalk and greywacke.

Accordingly, a stone aggregate may be inventively used, which is vulnerable for the alkali-silicic acid reaction.

It is further preferred for the weight ratio of the cement composition to the stone aggregate in the concrete mixture to be 1:1 to 1:10.

Further preferred, the fraction of olivine in the cement composition preferably is 30% by weight to 95% by weight, preferably 40% by weight to 95% by weight, further preferred 50% by weight to 95% by weight.

It is moreover preferred that the cement composition contains less than 10% by weight of Portland cement clinker, preferably less than 5% by weight of Portland cement clinker, further preferably less than 2% by weight of Portland cement clinker, further preferably essentially no Portland cement clinker, further preferably no Portland cement clinker at all.

According to a further preferred embodiment, the cement composition contains one or more SiO₂-containing additives. Preferably, the cement composition contains at least one additive having pozzolanic properties selected preferably from the following list: glass powder, glass, black coal flue ash, silica powder, thermally activated clay, volcanic ash, industrially occurring materials. Preferably, the one or more SiO₂-containing additives contain at least 20% by weight of amorphous SiO₂.

The task of the invention is further solved by a process for producing concrete while using the concrete mixture described above.

While performing the innovative process, the same advantages can be achieved as had been described above with reference to the innovative concrete mixture. Due to the use of the olivine-based binder it is possible to use alkali-sensitive stone aggregates for concrete production.

The task of the invention is further solved by a concrete made of the concrete mixture described above, in particular with addition of water. The inventive advantages and features described with respect to the inventive concrete mixture can be transferred to the inventive concrete.

It is preferred that the pH-value of the pore solution after hardening of the concrete mixture in the concrete is 7 to 11, preferably 7 to 10, further preferred 8 to 9.

Olivine-based binders enable a corresponding pH-value. Due to a neutral or moderate pH-value, the alkali-silicic acid reaction may be suppressed, also when an alkali-sensitive stone aggregate is used. Moreover preferred, the alkali concentration in the pore solution after hardening of the concrete mixture is less than 0.5 mmol/L, further preferred less than 0.1 mmol/L.

Olivine-based binders enable a corresponding alkali concentration. Due to such an alkali concentration, the alkali-silicic acid reaction may even be suppressed while using an alkali-sensitive stone aggregate.

Within the scope of the invention, the use of the inventive concrete mixture for producing concrete while avoiding and/or reducing the alkali silicic reaction is indicated.

Within the scope of the invention, the use of an olivine-based binder for avoiding and/or reducing the alkali-silicic acid reaction is further indicated.

1. A concrete mixture containing a cement composition and a stone aggregate, wherein
the cement composition contains an olivine-based binder and the stone aggregate is an alkali-sensitive stone aggregate, wherein the stone aggregate is selected from a stone including flint, opaline sandstone, siliceous chalk and greywacke.

2. The concrete mixture according to claim 1, wherein the stone aggregate is a stone aggregate of the category E-II or E-III according to the DAfStb alkali guideline: 2013-10.

3. The concrete mixture according to claim 1, wherein the sum of magnesium oxide and iron oxide in the cement composition is 20% by weight to 70% by weight.

4. The concrete mixture according to claim 1, wherein the weight ratio of the cement composition to the stone aggregate in the concrete mixture is 1:1 to 1:10.

5. The concrete mixture according to claim 1, wherein the fraction of olivine in the cement composition is 30% by weight to 95% by weight, preferably 40% by weight to 95% by weight, further preferred 50% by weight to 90% by weight.

6. The concrete mixture according to claim 1, wherein the cement composition contains less than 10% by weight of Portland cement clinker, preferably less than 5% by weight of Portland cement clinker, further preferably less than 2% by weight of Portland cement clinker, further preferably essentially no Portland cement clinker, further preferably no Portland cement clinker at all.

7. The concrete mixture according to claim 1, wherein the cement composition contains one or more SiO₂-containing additives, preferably, at least one additive having pozzolanic properties selected preferably from the list consisting of glass powder, glass, black coal flue ash, silica powder, thermally activated clay, volcanic ash, and industrially occurring materials, containing preferably at least 20% by weight of amorphous SiO₂.

8. A process for manufacturing concrete while using the concrete mixture according to claim 1.

9. Concrete manufactured from the concrete mixture according to claim 1.

10. Concrete according to claim 9, wherein the pH-value of the pore solution after hardening of the concrete mixture is 7 to 11, preferably 7 to 10, further preferred 8 to 9.

11. Concrete according to claim 9, wherein the alkali concentration in the pore solution after hardening of the concrete mixture is below 100, more preferred below 50 mmol/L.

12. The use of the concrete mixture according to claim 1, for manufacturing concrete while avoiding and/or reducing the alkali-silicic acid reaction.

13. The use of an olivine-based binder for avoiding and/or reducing the alkali-silicic acid reaction.
